(19) United States
(12) Patent Application Publication
(10) Pub. No.: US 2002/0036457 A1
(43) Pub. Date: Mar. 28, 2002

(54) Mask frame assembly and color picture tube utilizing the same

(76) Inventors: Ji-Hun Kim, Seoul (KR); Ki-Hun Song, Suwon-city (KR); Joon-Sup Kim, Seoul (KR); Woo-Yung Soh, Seoul (KR)

Correspondence Address: Robert E. Bushnell, Suite 300, 1522 K Street, N.W., Washington, DC, 20005-1202, US

(21) Appl. No.: 09/939,609

(22) Filed: Aug. 28, 2001

(30) Foreign Application Priority Data
Sep. 25, 2000 (KR) 56147/2000
Apr. 28, 2001 (KR) 23225/2001

(51) Int. Cl. H01J 29/80

(52) U.S. Cl. 313/407

(57) ABSTRACT

A mask frame assembly for a color picture tube includes a mask having a portion in which a plurality of electron beam passing holes are formed, a second frame for supporting the mask, a first frame in which the second frame is inserted, and an elastic member provided between the first and second frames for absorbing an impact, the elastic member including a first plate member having a first fixed portion fixed to the second frame and a second plate member to be coupled with the first plate member having a second fixed portion fixed to the first frame.

### CLAIM OF PRIORITY

This application makes reference to, incorporates the same herein, and claims all benefits accruing under 35 U.S.C. §119 from my applications SHADOW MASK FRAME ASSEMBLY FOR CRT filed with the Korean Industrial Property Office on Sep. 25, 2000 and there duly assigned Ser. No. 56147/2000, and MASK FRAME ASSEMBLY AND COLOR PICTURE TUBE UTILIZING THE SAME, filed with the Korean Industrial Property Office on Apr. 28, 2001 and there duly assigned Ser. No. 23225/2001.

### BACKGROUND OF THE INVENTION

1. Technical Field

The present invention relates to a color picture tube, and more particularly relates to a mask frame assembly which is installed adjacent to a fluorescent film inside a panel and which performs a color selection function, and a color picture tube utilizing the mask frame assembly.

2. Related Art

In a typical color picture tube adopted in computer monitors or televisions, three electron beams emitted from an electron gun pass through electron beam passing holes of a mask having a color selection function and land at red, green and blue fluorescent substances of a fluorescent film formed on a surface of a screen of a panel, so that the fluorescent substances are excited, forming an image. In the color picture tube forming an image, a mask having a color selection function is divided into a dot mask adopted in a computer monitor and a slot mask (or a slit mask) used in a television. In these dot mask and slot mask, surfaces of screens are designed to have curvatures corresponding to the curvature of a surface of a screen, or to be flat, considering landing of a deflected electron beam and distortion of an image.

The above designed mask is installed to be fixed to the frame and separated a predetermined distance from the fluorescent film formed at the inner surface of the panel. That is, a skirt portion of the mask having a holed portion in which a plurality of electron beam passing holes are formed is fixed to the frame. The frame is installed at the inner surface of the panel as a hook spring installed at the outer circumferential surface of the frame is coupled to a stud pin installed at the inner surface of the panel.

Since a mask frame assembly formed by coupling the frame and the mask is being suspended inside the panel, the mask frame assembly is not able to sufficiently absorb an impact applied from the outside. In particular, in an impact test of a color picture tube, since an unbearable impact is applied to the color picture tube, a suspension state of the mask frame assembly being suspended inside the panel or the mask supported by the frame is permanently deformed.

To solve the above problem, Korean Patent Publication No. 1998-087192 (claiming priority from Japanese Patent Application No. 9-120926) discloses a holder including a first member having a fitting portion coupled to a stub pin and a second member having a fixed portion having a thickness greater than that of the first member and fixed to a frame. A picture tube adopting the holder can simultaneously correct an error of color due to an external impact and an error of color due to thermal expansion of a mask frame during a long-term use thereof. However, this picture tube does not provide a great effect with respect to the unbearable impact.

Meanwhile, U.S. Pat. No. 5,982,085 discloses a picture tube having an improved shadow mask fixing apparatus. In this color picture tube, an additional bracket is installed at a corner portion of a frame to which a mask is fixed.

As can be seen from the above mask frame assembly examples, since the mask frame assembly absorbs an external impact by using a hook spring for supporting a mask frame with respect to a panel, there is a limit in absorbing a great impact. In particular, as disclosed in U.S. Pat. Nos. 3,638,063, 4,942,332, 4,926,089, and 4,973,283, in most masks used in a flat type picture tube, since the edge side of the mask is not supported when the mask is fixed to a frame, the mask vibrates more sensitively with respect to an impact applied from the outside. In other words, the mask is more sensitive to impacts, and the mask vibrates more readily in response to an impact.

Exemplars of recent efforts in the art include: U.S. Pat. No. 3,638,063 to Tachikawa et al., entitled GRID STRUCTURE FOR COLOR PICTURE TUBES, issued on Jan. 25, 1972, U.S. Pat. No. 5,982,085 to Lakshmanan et al., entitled COLOR CATHODE RAY TUBE WITH IMPROVED SHADOW MASK MOUNTING SYSTEM, issued on Nov. 9, 1999, U.S. Pat. No. 4,942,332 to Adler et al., entitled TIED SLIT MASK FOR COLOR CATHODE RAY TUBES, issued on Jul. 17, 1990, U.S. Pat. No. 6,037,709 to Nakagawa et al., entitled CATHODE RAY TUBE, issued on Mar. 14, 2000, U.S. Pat. No. 4,973,283 to Adler et al., entitled METHOD OF MANUFACTURING A TIED SLIT MASK CRT, issued on Nov. 27, 1990, and U.S. Pat. No. 4,926,089 to Moore, entitled TIED SLIT FOIL SHADOW MASK WITH FALSE TIES, a issued on May 15, 1990.

While these recent efforts provide advantages, I note that they fail to adequately provide an improved, efficient, and convenient mask frame assembly and color picture tube utilizing the mask frame assembly.

### SUMMARY OF THE INVENTION

To solve the above problems and others, it is an objective of the present invention to provide a tension mask frame assembly of a color picture tube which can prevent permanent deformation of a mask supported by a frame by improving a strength of absorbing an impact from the outside.

To achieve the first objective and others, there is provided a mask frame assembly for a color picture tube comprising a mask having a holed portion in which a plurality of electron beam passing holes are formed, a second frame for supporting the mask, a first frame in which the second frame is inserted, and at least one elastic member provided between the first and second frames for absorbing an impact, the elastic member including a first plate member having a first fixed portion fixed to the second frame and a second plate member to be coupled with the first plate member having a second fixed portion fixed to the first frame.

To achieve the first objective and others, there is provided a mask frame assembly for a color picture tube comprising a mask having a holed portion in which a plurality of electron beam passing holes are formed, a second frame for supporting the mask, a first frame in which the second frame is inserted, and an elastic member provided between the first and second frames for absorbing an impact, the elastic member including at least one bent portion between both end portions which are respectively fixed to the first and second frames.

It is another objective of the present invention to provide a color picture tube which can improve quality of an image by reducing transfer of vibrations and improving a vibration damping effect of the mask.

To achieve the second objective and others, there is provided a color picture tube comprising a panel having an inner surface on which a fluorescent film is formed and stud pins fixed at the inner surface thereof, a frame unit comprising a first frame suspended in the panel and having hook springs installed at the outer circumferential surface thereof to be coupled to the stud pins, and having a first flange portion extending inwardly, a second frame installed in the first frame and having a second flange portion corresponding to the first flange portion, and elastic members installed between the first and second flange portions, a mask fixed to the second frame and having a holed portion where a plurality of electron beam passing holes are formed, a funnel sealed to the panel and having a neck portion, an electron gun installed at the neck portion of the funnel for emitting an electron beam, and a deflection yoke installed at a cone portion of the funnel for deflecting the electron beam emitted from the electron gun.

To achieve these and other objects in accordance with the principles of the present invention, as embodied and broadly described, the present invention provides a mask frame assembly for a color picture tube, the assembly comprising: a mask forming a plurality of electron beam passing holes; a first frame; a second frame supporting said mask, said second frame being inserted in said first frame; and at least one elastic member absorbing an impact, said at least one elastic member being positioned between said first and second frames, said at least one elastic member comprising: a first plate member having a first fixed portion fixed to said second frame; and a second plate member having a second fixed portion fixed to said first frame, said second plate member being coupled with said first plate member at a conjunction region.

To achieve these and other objects in accordance with the principles of the present invention, as embodied and broadly described, the present invention provides a mask frame assembly for a color picture tube, the assembly comprising: a mask forming a plurality of electron beam passing holes; a first frame; a second frame for supporting said mask, said second frame being inserted into said first frame; at least one elastic member absorbing an impact, said elastic member being positioned between said first and second frames, said elastic member having a first end fixed to said first frame, a second end fixed to said second frame, and at least one bent portion between said first and second ends.

To achieve these and other objects in accordance with the principles of the present invention, as embodied and broadly described, the present invention provides a mask frame assembly for a color picture tube, the assembly comprising: a mask forming a plurality of electron beam passing holes; a first frame; a second frame supporting said mask, said second frame being inserted in said first frame; and at least one elastic member absorbing an impact, said at least one elastic member being positioned between said first and second frames.

To achieve these and other objects in accordance with the principles of the present invention, as embodied and broadly described, the present invention provides a color picture tube, comprising: a panel having an inner surface, said panel having a fluorescent film formed on said inner surface, said panel having stud pins fixed at said inner surface; a frame unit comprising: a first frame being suspended in said panel and having hook springs installed at an outer circumferential surface of said panel, said stud pins being coupled to said hook springs, said first frame having a first flange portion extending inwardly; a second frame being installed in said first frame and having a second flange portion corresponding to said first flange portion; and elastic members being installed between said first and second flange portions; a mask being fixed to said second frame and forming a plurality of electron beam passing holes; a funnel being sealed to said panel and having a neck portion; an electron gun being installed at said neck portion of said funnel and emitting an electron beam; and a deflection yoke being installed at a cone portion of said funnel and deflecting the electron beam emitted from said electron gun.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a partially cut-away perspective view showing a color picture tube, in accordance with the principles of the present invention;

FIG. 2 is an exploded perspective view showing a mask frame assembly, in accordance with the principles of the present invention;

FIG. 3 is a partially cut-away perspective view showing a state in which an elastic member is installed between the first and second frames, in accordance with the principles of the present invention;

FIG. 4 is a side view showing an elastic member according to another preferred embodiment, in accordance with the principles of the present invention;

FIGS. 5 through 7 are perspective view showing elastic members according to other preferred embodiments, in accordance with the principles of the present invention;

FIG. 8 is an exploded perspective view showing a mask frame assembly adopting an elastic member according to another preferred embodiment, in accordance with the principles of the present invention;

FIG. 9 is a partially cut-away section view of the mask frame of FIG. 8; and

FIG. 10 is a sectional view showing the state in which the mask frame assembly is installed inside the panel, in accordance with the principles of the present invention.

### DETAILED DESCRIPTION OF THE INVENTION

While the present invention will be described more fully hereinafter with reference to is the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions or constructions are not described in detail since they would obscure the invention in unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure. Additionally, the embodiments disclosed can be combined.

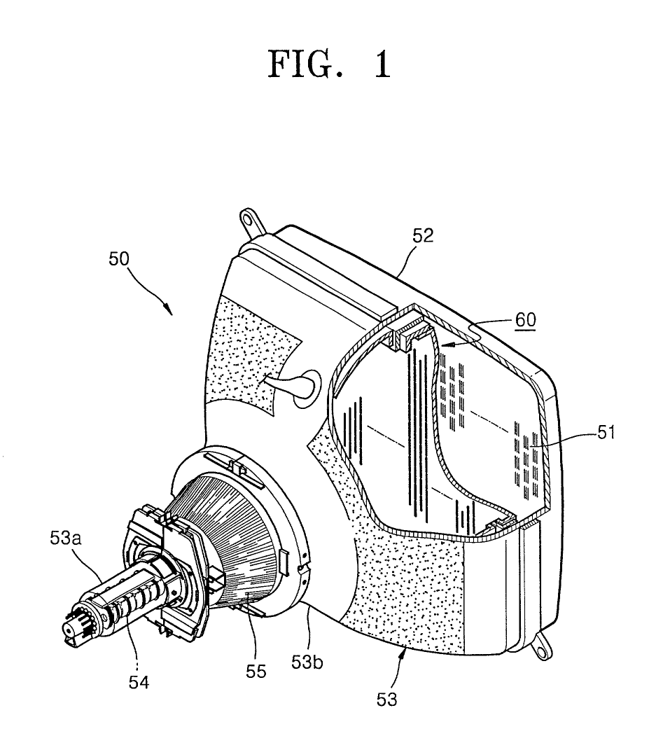

Referring to FIG. 1, a color picture tube 50 adopting a mask frame assembly according to the present invention includes a panel 52 in which a fluorescent film 51 having a predetermined pattern is formed on the inner surface thereof, and a mask frame assembly 60 installed inside the panel 52. The panel 52 is coupled to a funnel 53 forming a seal. An electron gun 54 is installed at a neck portion 53a of the funnel 53. A deflection yoke 55 for deflecting an electron beam emitted from the electron gun 54 to accurately land on each of fluorescent substances on the fluorescent film 51, is installed at the neck portion 53a and a cone portion 53b of the funnel 53.

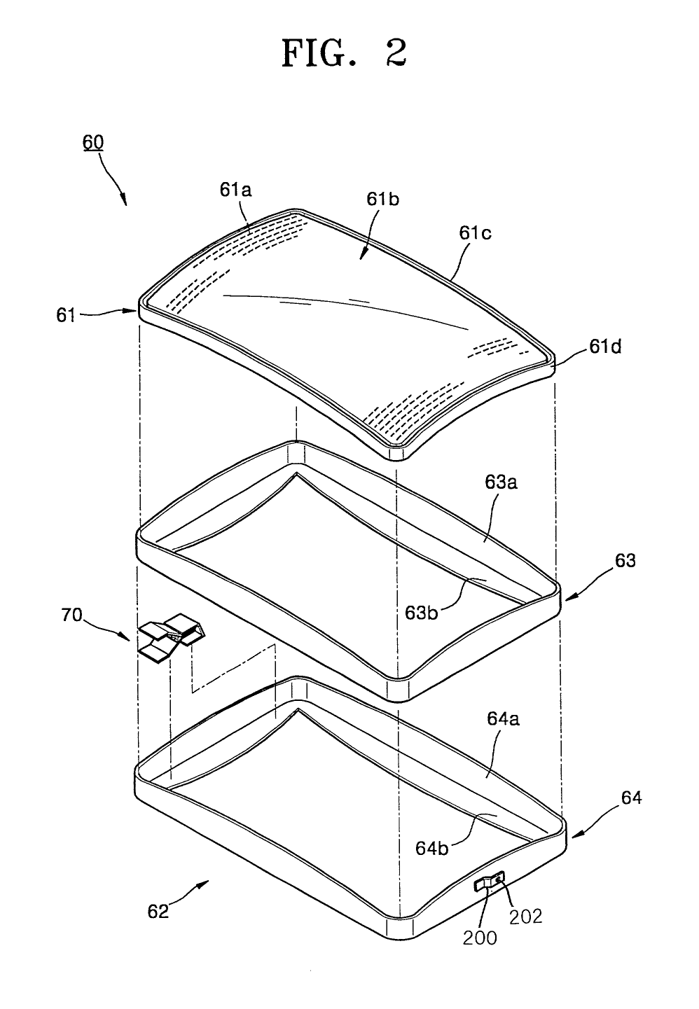

Referring FIG. 2, the mask frame assembly 60 according to a preferred embodiment of the present invention is suspended inside the panel 52 and includes a mask 61 having a color selection function of the electron beam emitted from the electron gun 54, and a frame unit 62 for supporting the mask 61.

The mask 61 includes a holed portion 61b where a plurality of electron beam passing holes 61a are formed, an unholed portion 61c extending from the holed portion 61b, and a skirt portion 61d perpendicularly bent from the unholed portion 61c. Here, the shape of the electron beam passing holes 61 a may be a dot or slit and the shape of the mask is not limited to the above-described preferred embodiment.

The frame unit 62 for supporting the mask 61 includes a first frame 64, a second frame 63, and at least one elastic member 70. The first frame 64 includes a first main body portion 64a having a rectangular shape and a first flange portion 64b inwardly extending from the lower end portion of the first main body portion 64a. The second frame 63 which is inserted in the first frame 64 includes a second main body portion 63a having a rectangular shape and a second flange portion 63b inwardly extending from the lower end portion of the second main body portion 63a. The elastic member 70 is installed between the first and second frames 64 and 63 and prevents transfer of an impact from the external to the mask 61 installed at the second frame 63.

Although the first and second frames 64 and 63 are shown in FIG. 2 by being substantially defined, any structure is possible which has a second frame for supporting a mask and an elastic member installed between the first frame for supporting the second frame and capable of absorbing an impact.

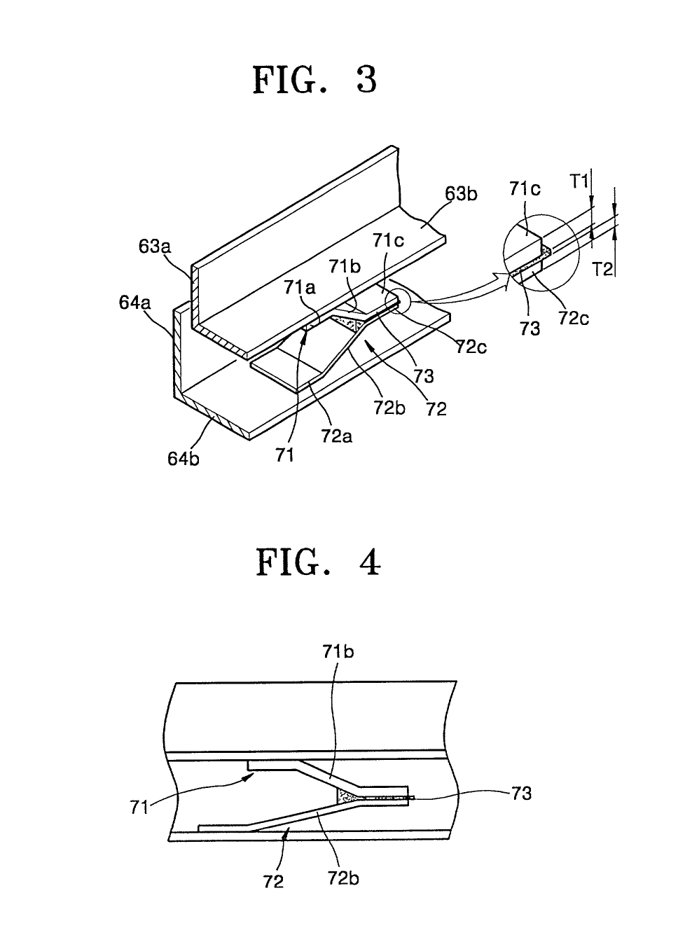

Examples of the elastic member 70 installed between the first and second frames 64 and 63 are shown in FIGS. 3 through 7. As shown in the drawings, the elastic member 70 is formed of a leaf spring and includes a first plate member 71 and a second plate member 72. The first plate member 71 has a first fixed portion 71a fixed to the bottom of the second flange portion 63b of the second frame 63, a first extension portion 71b extending from the first fixed portion 71a at a predetermined angle, and a first conjunction portion 71c extending from an end portion of the first extension portion 71b parallel to the first fixed portion 71a. The second plate member 72 has a second conjunction portion 72c combined with the first conjunction portion 71c, a second extension portion 72b extending from the second conjunction portion 72c and angled in the direction opposite to that of the first extension portion 71b, and a second fixed portion 72a extending from the end portion of the second extension portion 72b and fixed to the upper surface of the first flange portion 64b of the first frame 64. A leaf spring can be a spring made of superposed strips, plates, or leaves, for example.

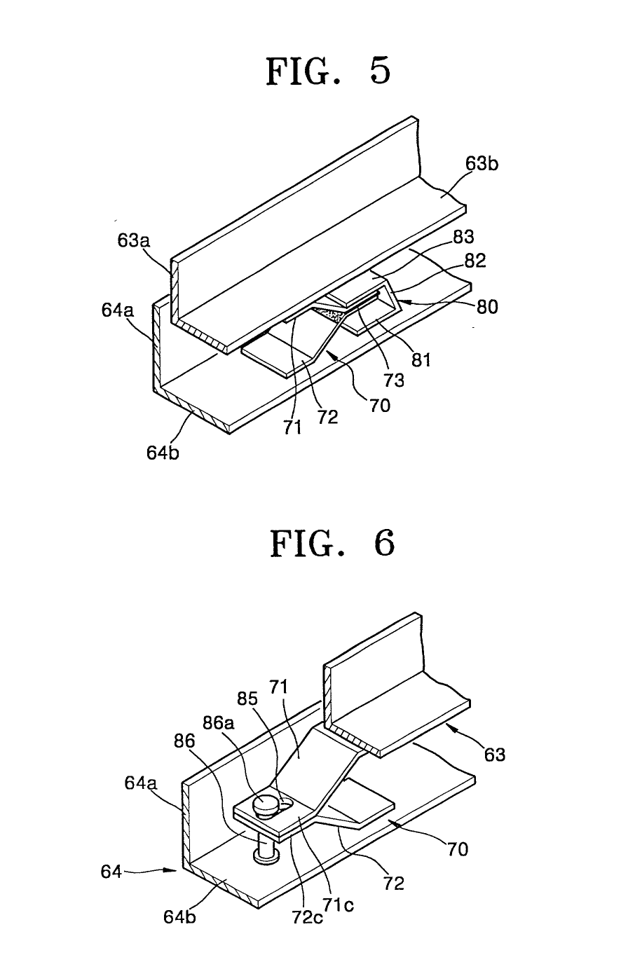

The first conjunction portion 71c together with the second conjunction portion 72c can be referred to as a conjunction region of the first and second plate members 71 and 72, or can be referred to as a conjunction portion of the first and second plate members 71 and 72. As shown in FIGS. 3 and 4, the first conjunction portion 71c can deviate away from the second conjunction portion 72c at a deviation region near where the extension portions 71b, 72b meet the conjunction portions 71c, 72c. The damping member 73 is interposed between the conjunction portions 71c, 72c. The part of the damping member 73 located at the deviation region has a first thickness. The part of the damping member 73 located between the parallel parts of the conjunction portions 71c, 72c has a second thickness. The first thickness is larger than the second thickness, as shown in FIGS. 3 and 4.

Here, a damping member 73 for absorbing an impact may be interposed between the first and second conjunction portions 71c and 72c. Metal fiber may be used as the damping member 73. The first and second plate members 71 and 72 are formed of elastic flat members. The elastic force of the first plate member 71 is greater than that of the second plate member 72. The thickness T1 of the first plate member 71 is greater than the thickness T2 of the second plate member 72. The second extension portion 72b of the second plate member 72 may be formed to be longer than the first extension portion 71b of the first plate member 71, as shown in FIG. 4.

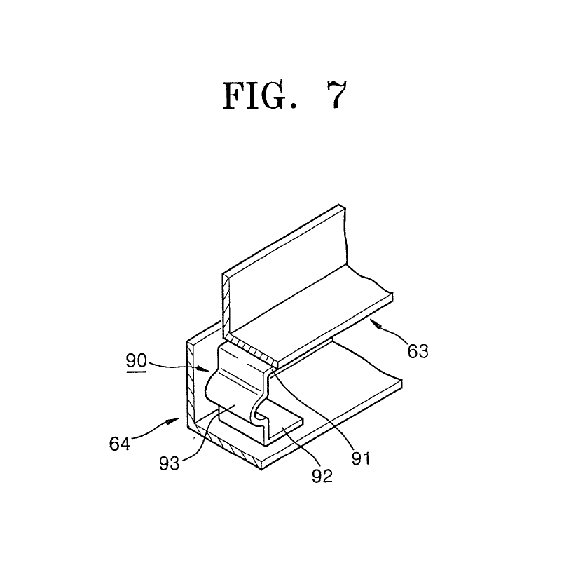

In the above preferred embodiment, to improve a damping strength of the elastic member 70, a stopper 80 for connecting the first frame 64 and the first and second conjunction portions 71c and 72c of the first and second plate members 71 and 72 may be installed as shown in FIG. 5.

The stopper 80 prevents vibrations of the elastic member 70 generated as the first and second frames 64 and 63 vibrate. The stopper 80 includes a base portion 81 fixed to the upper surface of the first flange portion 64b of the first frame 64, and a support portion 82 extending from the base portion 81 toward the first conjunction portion 71c to be combined with the first conjunction portion 71c. A level portion 83 extending from the end portion of the support portion 82 parallel to the first conjunction portion 71c so that it can be coupled to the first conjunction portion 71c.

In another preferred embodiment of the stopper, as shown in FIG. 6, a slot 85 is formed in a lengthwise direction in the conjunction portions 71c and 72c of the first and second plate members 71 and 72 forming the elastic member 70, and a support rod 86 is fixed to the upper surface of the first flange portion 64b of the first frame 64 and inserted in the slot 85. A head portion 86a is installed at the end portion of the support rod 86 so that a conjunction portion does not protrude from the support rod 86.

FIG. 7 shows an elastic member 90 according to yet another preferred embodiment of the present invention. Both end portions 91 and 92 of the elastic member 90 are fixed to the second frame 63 for supporting a mask and the first frame 64 into which the second frame 63 is inserted in the first frame 64. The elastic member 90 includes at least one bent portion 93 between both end portions 91 and 92. The bent portion 93 is bent at a predetermined angle with respect to the lengthwise direction of the elastic member 90, but not limited thereto.

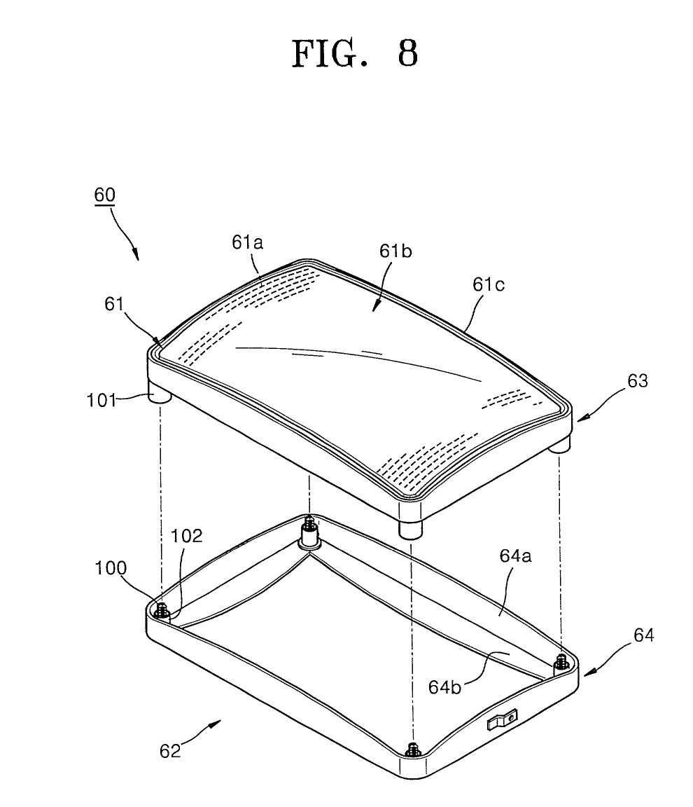

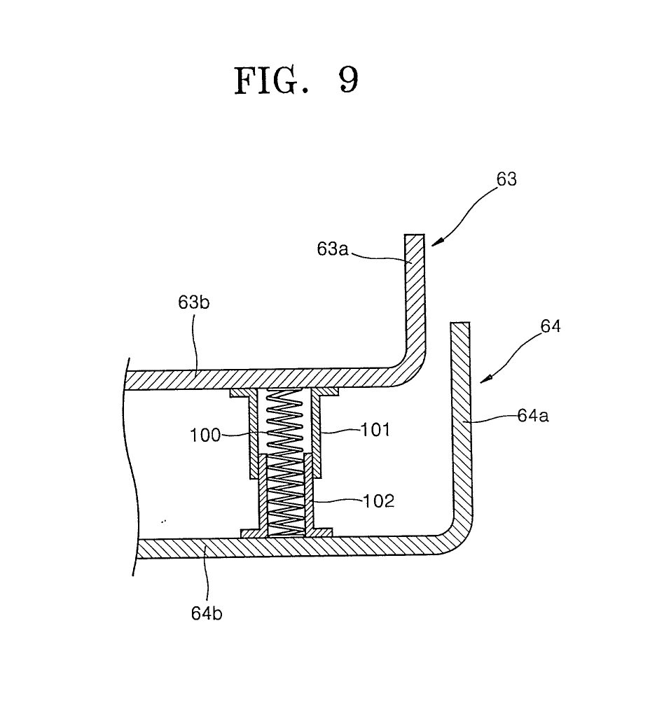

FIGS. 8 and 9 show an elastic member according to yet another preferred embodiment of the present invention. As shown in the drawings, a plurality of coil springs 100 which are elastic members are provided between the upper surface of the first flange portion 64b of the first frame 64 and the bottom surface of the second flange portion 63b of the second frame 63. First and second cylindrical pads 101 and 102 are installed at the bottom surface of the second flange portion 63b and the upper surface of the first flange portion 64b, respectively, to support the springs 100.

The first and second pads 101 and 102, as shown in FIG. 9, are coupled to be capable of sliding in the lengthwise direction so that the second frame 63 is not vibrated in the horizontal direction with respect to the first frame 64. In other words, as shown in FIG. 9, an impact can cause the second frame 63 to move down toward the first frame 64, and this impact will cause coil spring 100 to be compressed, and the second pad 102 will slide up into the first pad 101. The first pad 101 and the second pad 102 are coupled to each other in a way that lets them slide in this manner. The second pad 102 can slide up within the confines of the first pad 101 toward the second frame 63, as shown in FIG. 9.

The operation of the above-described mask frame assembly of a color picture tube according to the present invention will now be described in detail with reference to the accompanying drawings.

In the color picture tube having the above structure, an electron beam emitted from the electron gun 54 which is deflected by the deflection yoke 55 passes through the electron beam passing holes 61a of the mask and lands the fluorescent film 51 to excite the fluorescent substances, thus forming an image. When an impact from the outside is applied to the color picture tube during the above process, the mask frame assembly 60 suspended at the panel 52 vibrates. Since the frame unit supporting the mask 61 is formed of the first and second frames 64 and 63 where the elastic member 70 is interposed, vibrations applied to the mask are minimized so that a howling phenomenon according to the vibrations of the mask can be reduced.

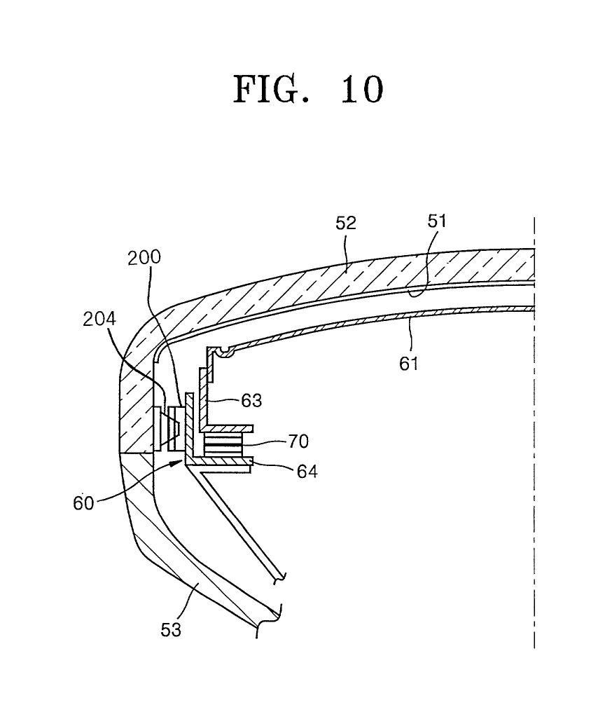

In detail, as shown in FIG. 10, the impact applied to the color picture tube is transferred to the mask frame assembly 60 suspended at the panel 52. The impact is transferred to the first frame 64 via the stud pin fixed to the inner surface of the panel 52 and the hook spring.

A hook spring 200 is shown in FIGS. 2 and 10. In FIG. 2, the hole 202 in the hook spring 200 is shown. The hole 202 is penetrated by the stud pin 204, as shown in FIG. 10.

The impact transferred to the first frame 64 is secondarily transferred the second frame 63 via the elastic member 70 and finally to the mask 61. In this procedure, since the elastic member 70 has the conjunction portions 71c and 72c combined with each other and the first and second fixed portions 71a and 72a installed at the first and second flange portions 64b and 63b of the first and second frames 64 and 63, respectively, the vibrations transferred between the first and second frames 64 and 63 can be reduced by the elastic deformation of the elastic member 70. In particular, since metal fiber, which is the damping member 73, is installed between the first and second conjunction portions 71c and 72c and the first and second conjunction portions 71c and 72c are supported by the stopper 80 (as shown in FIGS. 2 through 5), the distance of movement of the elastic member 70 according to the elastic deformation is limited. Also, the elastic deformation is reduced by the support portion 82 of the stopper 80 so that vibrations due to the impact can be reduced, as shown in FIGS. 2 through 5.

As shown in FIG. 8 and 9, when the elastic member is formed of the coil springs 100, the impact is absorbed by the springs 100 interposed between the first and second flange portions 63b and 64b and attenuated by the pads 101 and 102 coupled to overlap each other and capable of sliding.

In particular, when an impact test is performed with respect to a picture tube, the picture tube receives a great impact. In the above-described color picture tube having the above structure according to the present invention, the impact applied to the mask 61 is attenuated so that the mask is prevented from being permanently deformed.

It is noted that the present invention is not limited to the preferred embodiment described above, and it is apparent that variations and modifications by those skilled in the art can be effected within the spirit and scope of the present invention defined in the appended claims.

As described above, in the mask frame assembly according to the present invention and the color picture tube utilizing the mask frame assembly, the impact applied to the mask is minimized so that the howling phenomenon of an image due to vibrations of the mask can be reduced and the quality of the image can be improved. Also, a set impact can be attenuated by arbitrarily adjusting strength of the elastic and damping member.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A mask frame assembly for a color picture tube, the assembly comprising:
a mask forming a plurality of electron beam passing holes;
a first frame;
a second frame supporting said mask, said second frame being inserted in said first frame; and
elastic members absorbing an impact, said elastic members being positioned between said first and second frames, each one of said elastic members comprising:
a first plate member having a first fixed portion fixed to said second frame; and
a second plate member having a second fixed portion fixed to said first frame,
said second plate member being coupled with said first plate member at a conjunction region.

2. The assembly of claim 1, said first plate member having a first strength, said second plate member having a second strength, said first strength being greater than said second strength.

3. The assembly of claim 1, said first p late member having a first conjunction portion, said second plate member having a second conjunction portion, said second plate member being coupled with said first plate member at said conjunction region when said second conjunction portion is coupled with said first conjunction portion.

4. The assembly of claim 3, further comprising a damping member being interposed between said first and second conjunction portions.

5. The assembly of claim 4, said damping member being metal fiber.

6. The assembly of claim 1, said first plate member having a first thickness, said second plate member having a second thickness, said first thickness being greater than said second thickness.

7. The assembly of claim 1, said first conjunction portion of said first plate member and said second conjunction portion of said second plate member deviating away from each other at a deviation region.

8. The assembly of claim 7, further comprising a damping member being interposed between said first and second conjunction portions.

9. The assembly of claim 8, said damping member having a first thickness at a first location between said first and second conjunction portions, said damping member having a second thickness at said deviation region, said second thickness being larger than said first thickness.

10. The assembly of claim 1, further comprising a stopper having a first end fixed to said first frame and having a second end supported at said conjunction region.

11. The assembly of claim 10, said first end of said stopper corresponding to a base portion, said stopper including an extension portion extending from said base portion toward said conjunction region.

12. The assembly of claim 11, said second end being coupled with said conjunction region.

13. The assembly of claim 10, said stopper being a support rod having said first end and said second end, said second end of said support rod being received by a slot formed by said first and second plate members at said conjunction region.

14. The assembly of claim 13, the slot being formed at said conjunction region to extend in a direction along at least one of said elastic members toward said first fixed portion.

15. The assembly of claim 10, said stopper being a support rod having said first end and said second end, said second end of said support rod being inserted into a slot formed at said conjunction region.

16. A mask frame assembly for a color picture tube, the assembly comprising:
a mask forming a plurality of electron beam passing holes;
a first frame;
a second frame supporting said mask, said second frame being inserted in said first frame; and
elastic members absorbing an impact, said elastic members being positioned between said first and second frames.

17. The assembly of claim 16, at least one of said elastic members being a leaf spring.

18. The assembly of claim 16, at least one of said elastic members being a coil spring.

19. The assembly of claim 18, further comprising:
a first pad being positioned at a surface on said first frame; and
a second pad being positioned at a surface on said second frame to face said first pad, said first and second pads being slidably coupled to each other.

20. The assembly of claim 19, said coil spring having a first end coupled to said first pad, and having a second end coupled to said second pad.

21. The assembly of claim 16, at least one of said elastic members having a first end fixed to said first frame, a second end fixed to said second frame, and at least one bent portion between said first and second ends.

22. The assembly of claim 21, said at least one bent portion being formed by bending said elastic member at a predetermined angle.

23. The assembly of claim 16, at least one of said elastic members further comprising a damping member.

24. A color picture tube, comprising:
a panel having an inner surface, said panel having a fluorescent film formed on said inner surface, said panel having stud pins fixed at said inner surface;
a frame unit comprising:
a first frame being suspended in said panel and having hook springs installed at an outer circumferential surface of said panel, said stud pins being coupled to said hook springs, said first frame having a first flange portion extending inwardly;
a second frame being installed in said first frame and having a second flange portion corresponding to said first flange portion; and
elastic members being installed between said first and second flange portions;
a mask being fixed to said second frame and forming a plurality of electron beam passing holes;
a funnel being sealed to said panel and having a neck portion;
an electron gun being installed at said neck portion of said funnel and emitting an electron beam; and
a deflection yoke being installed at a cone portion of said funnel and deflecting the electron beam emitted from said electron gun.

25. The color picture tube of claim 24, at least one of said elastic members comprising:
a first plate member having a first fixed portion fixed to said first flange portion of said first frame; and
a second plate member having a second fixed portion and a conjunction end, said second fixed portion being fixed to said second flange portion of said second frame, said conjunction end being combined with said first plate member.

26. The assembly of claim 25, said first plate member having a first thickness, said second plate member having a second thickness, said first thickness being greater than said second thickness.

27. The assembly of claim 25, said at least one of said elastic members further comprising a stopper having a first end fixed to said first flange portion of said first frame and having a second end supported at said conjunction end of said second plate member.

28. The color picture tube of claim 25, said first plate member having a first strength, said second plate member having a second strength, said first strength being greater than said second strength.

29. The color picture tube of claim 24, at least one of said elastic members comprising:
a first plate member having a first fixed portion and a first conjunction end, said first fixed portion being fixed to said first flange portion of said first frame;
a second plate member having a second fixed portion and a second conjunction end, said second fixed portion being fixed to said second flange portion of said second frame; and
a damping member, said second conjunction end being coupled to said first conjunction end with said damping member disposed between said first and second conjunction ends.

30. The color picture tube of claim 29, said damping member corresponding to a metal fiber.
